(19) United States
(12) Patent Application Publication
(10) Pub. No.: US 2014/0323111 A1
(43) Pub. Date: Oct. 30, 2014

(54) CONTROL METHOD FOR INCOMING MESSAGE AND MOBILE TERMINAL USING THE SAME

(71) Applicant: TENCENT TECHNOLOGY (SHENZHEN) COMPANY LIMITED, Shenzhen City (CN)

(72) Inventor: JING NING, Shenzhen City (CN)

(73) Assignee: TENCENT TECHNOLOGY (SHENZHEN) COMPANY LIMITED, Shenzhen City (CN)

(21) Appl. No.: 14/259,138

(22) Filed: Apr. 22, 2014

Related U.S. Application Data
(63) Continuation of application No. PCT/CN2014/070235, filed on Jan. 7, 2014.

(30) Foreign Application Priority Data
Apr. 24, 2013 (CN) 201310143768.X

(51) Int. Cl. H04M 1/725; H04W 4/02; H04W 4/12

(52) U.S. Cl. CPC H04M 1/72577; H04W 4/12; H04M 1/72572; H04W 4/027
USPC 455/418; 455/26.1

(57) ABSTRACT

A control method for incoming messages includes steps of: controlling a mobile terminal to enter into a safe driving mode in response to a receiving of a command for controlling the mobile terminal to enter into the safe driving mode; obtaining a predetermined block condition and determining whether there is a need to automatically block an incoming message or not according to the obtained predetermined block condition when the incoming message is received by the mobile terminal; and rejecting and responding the incoming message with a predetermined message when it is determined that there is a need to automatically block the incoming message. A mobile terminal is also provided.

### CROSS-REFERENCE TO RELATED APPLICATION

This application is a continuation application of International (PCT) Patent Application No. PCT/CN2014/070235 filed on Jan. 7, 2014, now pending and designating the United States, which also claims benefit of China Patent Application No. 201310143768.X, filed on Apr. 24, 2013. The entirety of the above-mentioned patent applications is hereby incorporated by reference herein and made a part of this specification.

### FIELD

The present invention relates to the field of communication technology and the field of mobile, and more particularly relates to a control method for incoming messages and a mobile terminal using the same.

### BACKGROUND

With the development of society, mobile terminals, such as mobile phones, have become an important tool for real-time communication between people and also brought great convenience to people's work and daily life.

It is pretty common that drivers may receive incoming phone calls or text messages while driving and most of them may directly answer the incoming phone calls or check the incoming text messages without thinking about the safety. However, this behavior is pretty dangerous due to: firstly, drivers may not focus on driving while answering the incoming phone calls or checking the incoming text messages, which may cause the drivers fail to response some unexpected situations; secondly, drivers may use one hand for driving and the other hand for answering the incoming phone calls or checking the incoming text messages, which may lead driving security issues. Besides, even the driver select not to answer the incoming phone calls or check the incoming text messages, the ringing ringtones may still bother the drivers and cause some dangerous situations. Thus, no matter the driver select to either or not answer the incoming phone calls or check the incoming text messages, accidents may still happen and put the drivers in dangerous situations.

To prevent the aforementioned problems from occurring, today's mobile phone is designed with some protection mechanisms. For example, some mobile phones may be designed with a vibration mode function for incoming phone calls and text messages; or users may wear headphones to answer the incoming phone calls. However, some problems may be still resulted in from the aforementioned mechanisms. For example, if a mobile phone is set to vibration mode but the user of the mobile phone does not answer the incoming phone call in time, some misunderstandings between the caller of the incoming phone call and the user of the mobile phone may occur. Besides, even the user can answer phone calls through the headphone and has his/her two hands free, the user may still be bothered by the ringtones of the incoming phone calls or test messages, and consequentially the driver may have safety risks while driving.

### SUMMARY

A control method for incoming phone calls and text messages and a mobile terminal using the aforementioned control method is provided; thus, a driver can have a higher security while driving.

An embodiment of the present invention provides a control method for incoming messages, which includes steps of: controlling a mobile terminal to enter into a safe driving mode in response to a receiving of a command for controlling the mobile terminal to enter into the safe driving mode; obtaining a predetermined block condition and determining whether there is a need to automatically block an incoming message or not according to the obtained predetermined block condition when the incoming phone call or the incoming text message are received by the mobile terminal; and automatically rejecting or responding the incoming message with a predetermined message when it is determined that there is a need to automatically block the incoming message.

Another embodiment of the present invention provides a mobile terminal, which includes a safe driving mode control module, a block determination module and an incoming message control module. The safe driving mode control module is configured to control the mobile terminal to enter into a safe driving mode in response to a receiving of a command for controlling the mobile terminal to enter into the safe driving mode. The block determination module is configured to obtain a predetermined block condition and determine whether there is a need to automatically block an incoming message or not according to the obtained predetermined block condition when the incoming message is received by the mobile terminal. The incoming message control module is configured to automatically reject or respond the incoming message with a predetermined message when it is determined that there is a need to automatically block the incoming message.

In summary, by sequentially controlling a mobile terminal to enter into a safe driving mode, determining whether there is a need to automatically block the incoming phone call or the incoming text message or not according to an obtained predetermined block condition when the incoming phone call or the incoming text message are received by the mobile terminal, and automatically rejecting to answer the incoming phone call and automatically responding the incoming phone call or the incoming text message with a predetermined text message when it is determined that there is a need to automatically block the incoming phone call or the incoming text messages, the control method for incoming phone calls and text messages in accordance with an embodiment of the present invention can prevent the driver from being bothered by the incoming phone calls and text messages while driving and consequentially the safety of the driver is guaranteed.

### BRIEF DESCRIPTION OF THE DRAWINGS

The present disclosure will become more readily apparent to those ordinarily skilled in the art after reviewing the following detailed description and accompanying drawings, in which:

FIG. 1 is a flowchart illustrating a control method for incoming phone calls and text messages in accordance with an embodiment of the present invention;

FIGS. 2A˜2D are flowcharts illustrating a control method for incoming phone calls and text messages in accordance with another embodiment of the present invention;

FIG. 2E is a schematic view illustrating a mobile terminal controlled to display a prompt window on a display panel thereof for prompting the driver to selectively enter the mobile terminal into the safe driving mode when the alarm sound;

FIG. 2F is a schematic view illustrating a mobile terminal being entered into the safe driving mode;

FIG. 2G is a schematic view illustrating a mobile terminal displaying specific information corresponding to the blocked incoming phone call or the blocked incoming text message on a display panel of the mobile terminal;

FIG. 3 is a schematic block view of a mobile terminal in accordance with an embodiment of the present invention; and

FIG. 4 is a schematic block view of a mobile terminal in accordance with another embodiment of the present invention.

### DETAILED DESCRIPTION OF PREFERRED EMBODIMENTS

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

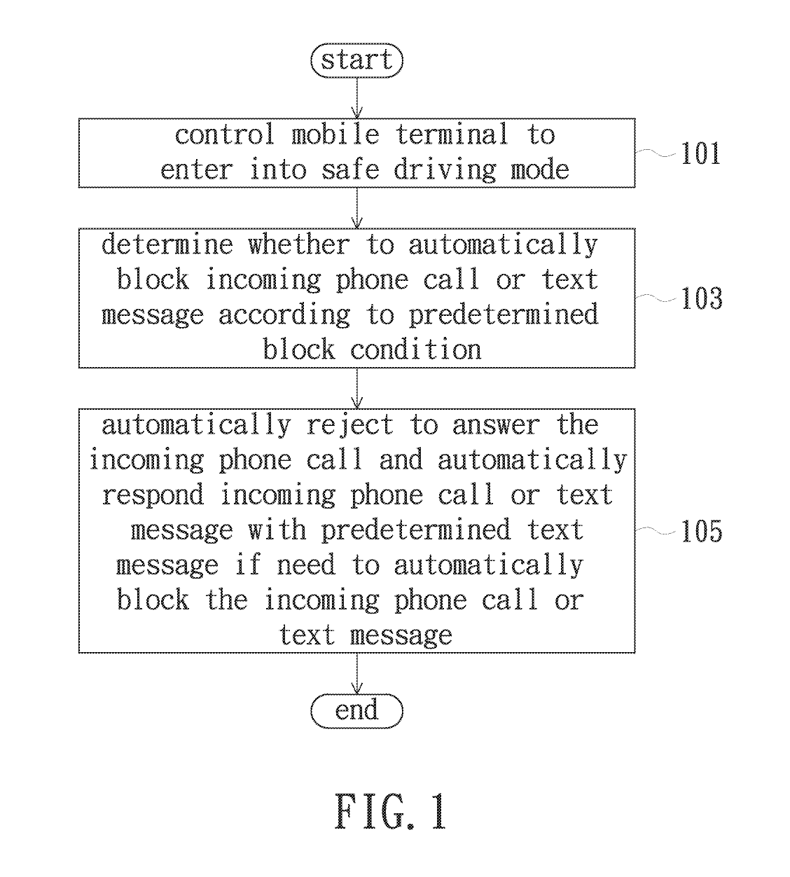

FIG. 1 is a flowchart illustrating a control method for incoming messages in accordance with an embodiment of the present invention. The control method in this embodiment may include the following steps 101˜105. Hereafter the control method of the present invention is exemplarily illustrated by for incoming phone calls and text messages; however, it is to be noted that the control method of the present invention may also apply to other specific messages, such as voice messages, video messages, sounds for reminding to update systems or applications, or sounds of alarm clocks, and the present invention is not limited thereto. In addition, hereafter a mobile terminal corresponding to the aforementioned control method is exemplified by a mobile phone; however, it is to be noted that the mobile terminal of the present invention may also apply to other specific devices, such as mobile computers, pads, or any wearable devices, and the present invention is not limited thereto.

Step 101: controlling a mobile terminal to enter into a safe driving mode in response to a receiving of a command for controlling the mobile terminal to enter into the safe driving mode.

In one embodiment, the safe driving mode herein is referred to that a user of the mobile terminal therein is capable of being prevented from being bothered by an incoming phone call or an incoming text message.

Step 103: obtaining a predetermined block condition and determining whether there is a need to automatically block an incoming phone call or an incoming text message or not according to the obtained predetermined block condition when the incoming phone call or the incoming text message are received by the mobile terminal.

In one embodiment, the predetermined block condition may be set based on actual needs. For example, the predetermined block condition may be related to a vehicle speed; that is, the incoming phone call or the incoming text message received by the mobile terminal will be automatically block if the predetermined block condition satisfies some specific requirements, such as the moving vehicle is having a speed higher than a predetermined speed.

Step 105: rejecting to answer the incoming phone call and automatically responding the incoming phone call or the text message with a predetermined text message if it is determined that there is a need to automatically block the incoming phone call or the incoming text message.

In one embodiment, the predetermined text message may have text content or voice content recorded in advance.

In summary, the control method for incoming phone calls and text messages provided in this embodiment includes steps of: controlling a mobile terminal to enter into a safe driving mode; determining whether there is a need to automatically block the incoming phone call or the incoming text message or not according to an obtained predetermined block condition when the incoming phone call or the incoming text message are received by the mobile terminal; and automatically rejecting to answer the incoming phone call and automatically responding the incoming phone call or the incoming text message with a predetermined text message when it is determined that there is a need to automatically block the incoming phone call or the incoming text message. Thus, by way of automatically rejecting to answer the incoming phone call and automatically responding the incoming phone call or the incoming text message with a predetermined text message while a driver is driving a vehicle and the vehicle is having a relatively high speed, the driver can be prevented from being bothered by the incoming phone call or text message and consequentially the safety of the driver is guaranteed.

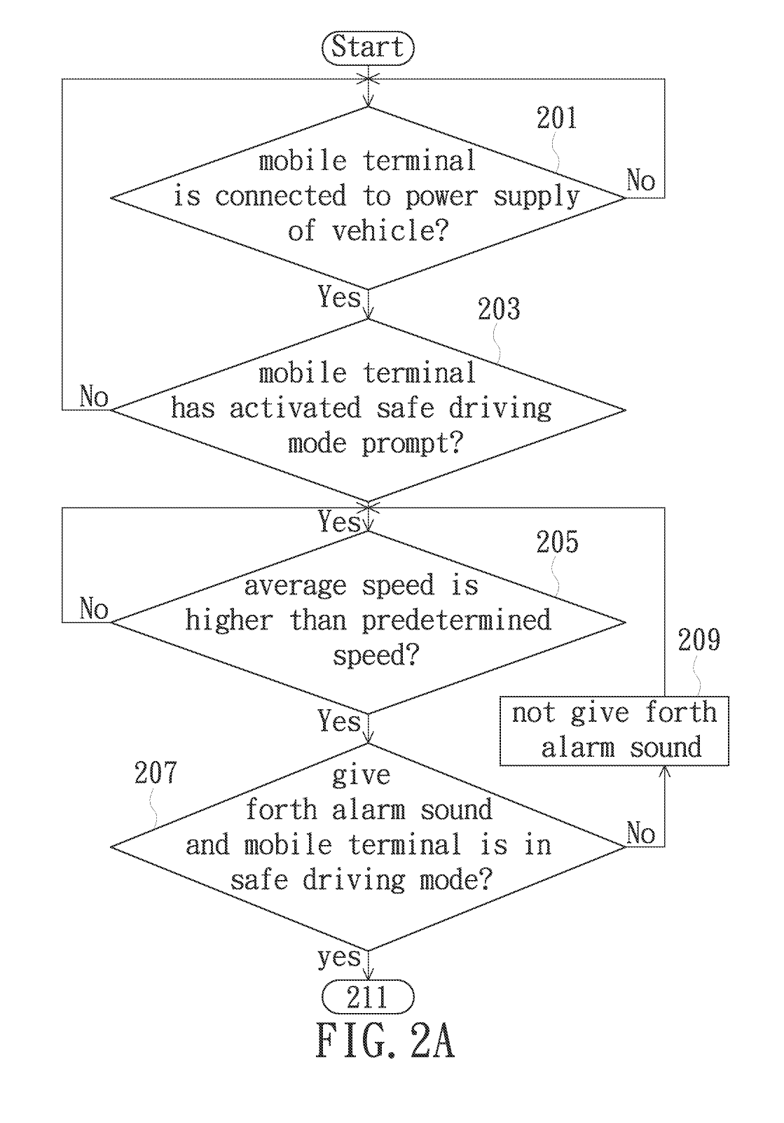

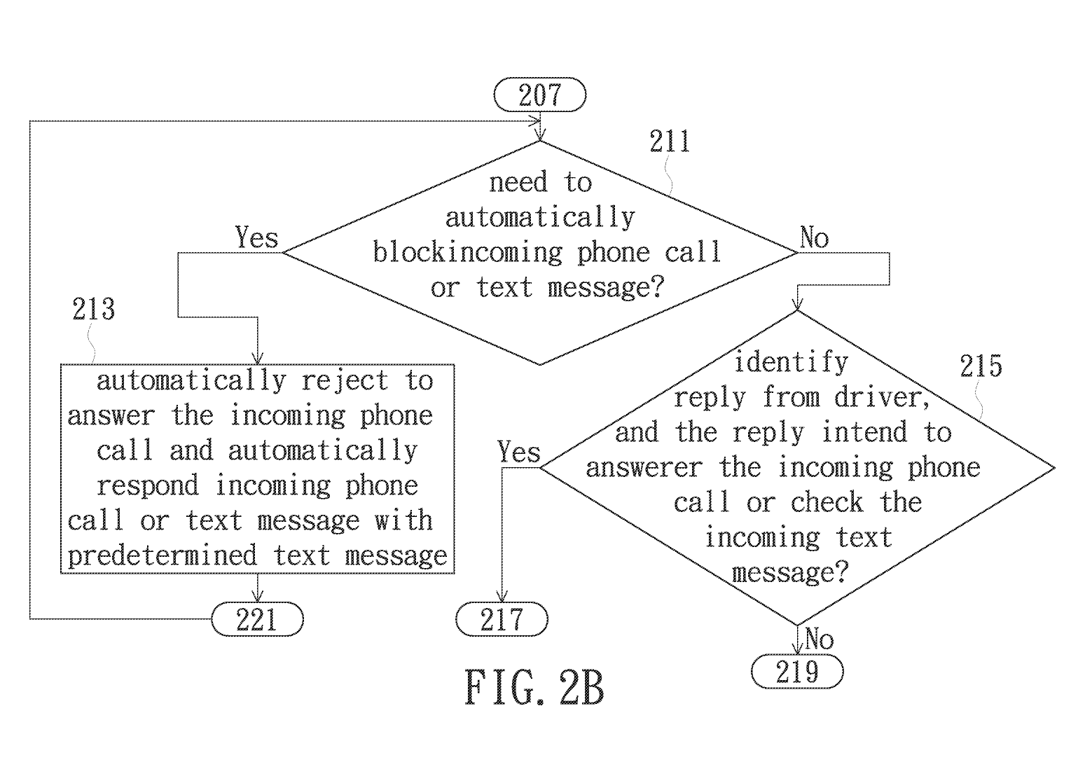

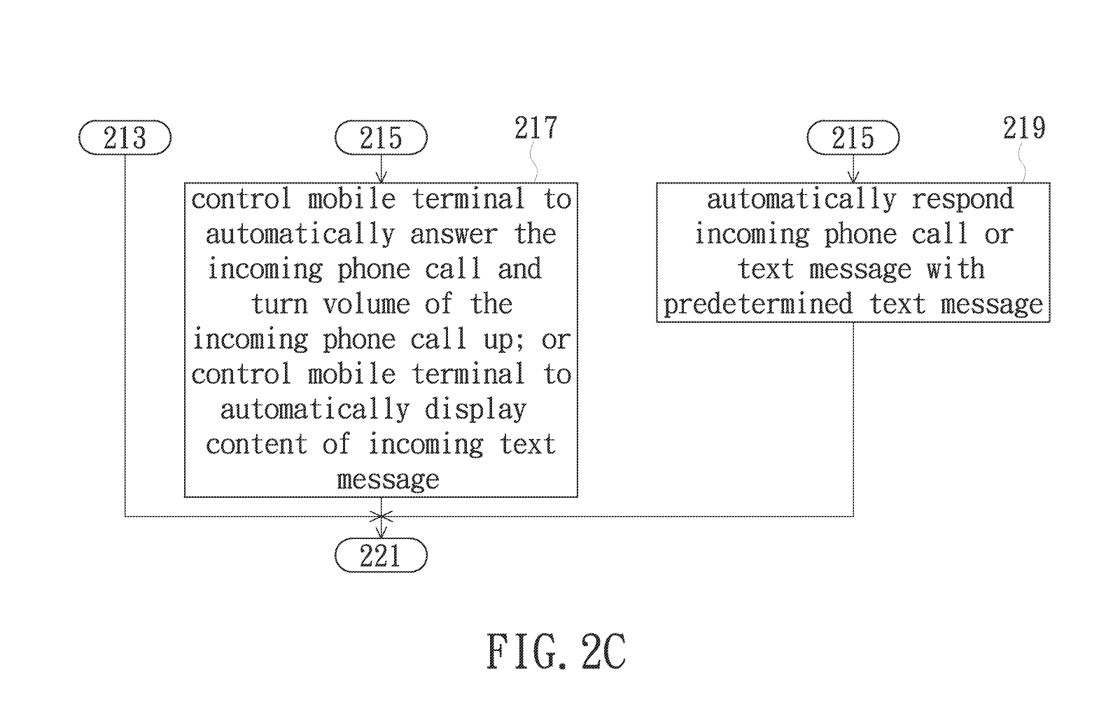

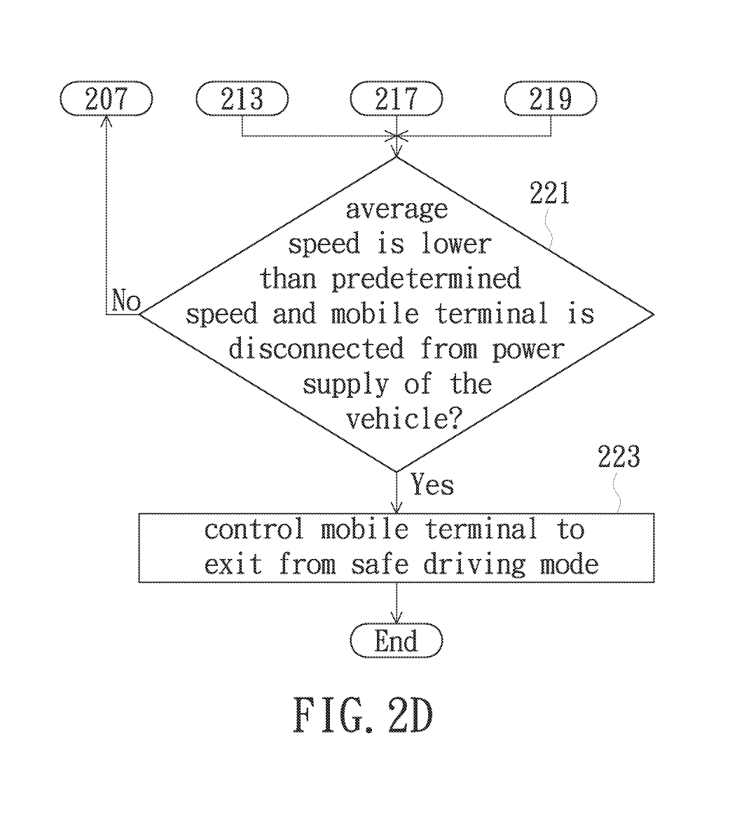

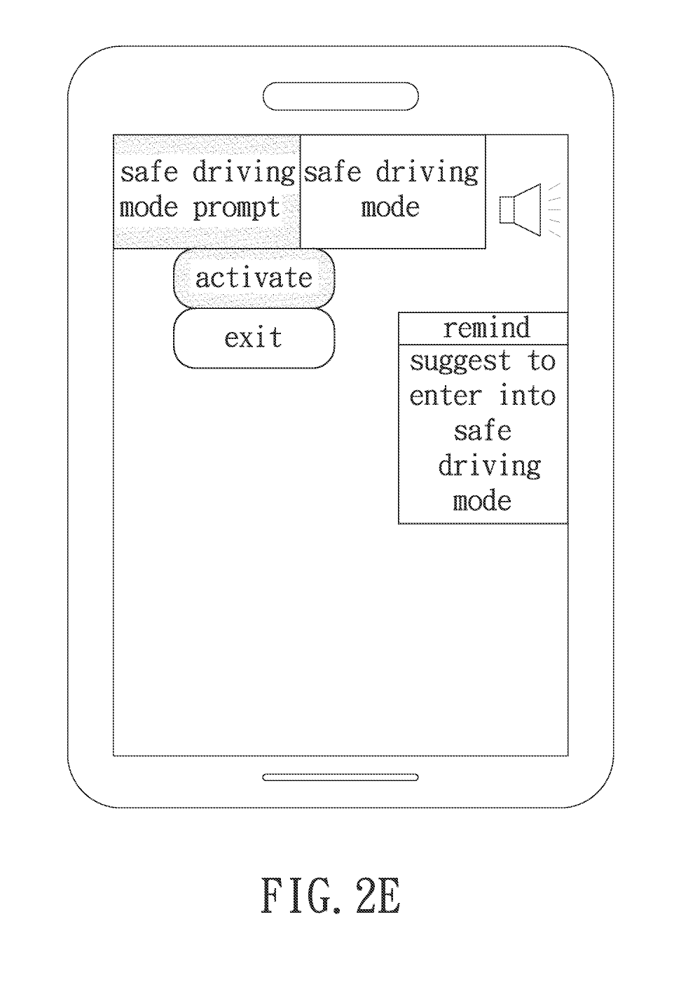

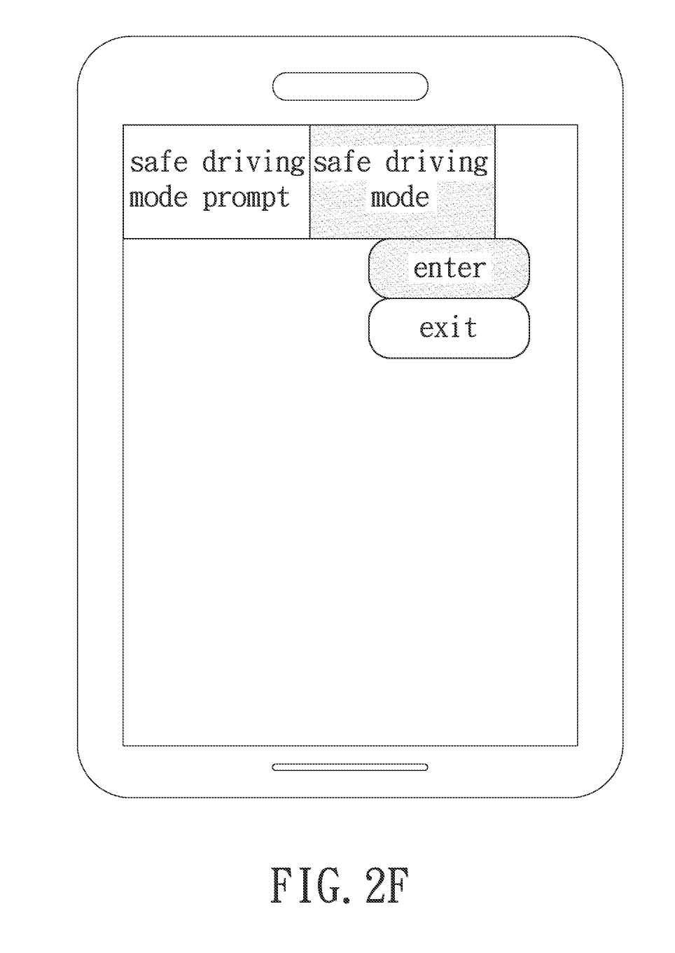

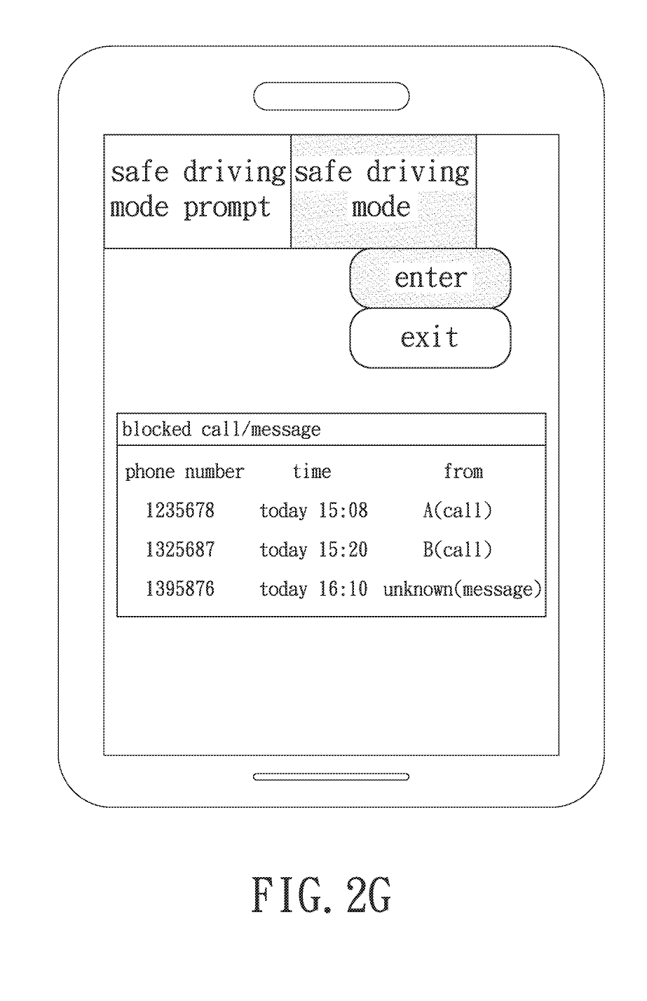

FIGS. 2A˜2D are flowcharts illustrating a control method for incoming phone calls and text messages in accordance with another embodiment of the present invention; wherein the control method of FIGS. 2A˜2D is developed based on the control method of FIG. 1. The control method for incoming phone calls and text messages in this embodiment may include the following steps 201˜223.

Step 201: determining that whether a mobile terminal has activated a safe driving mode prompt or not. The control method in this embodiment goes to step 203 if yes; alternatively, the control method goes back to step 201 if no.

In one embodiment, once the safe driving mode prompt has been activated, the mobile terminal may be controlled to give forth an alarm sound to prompt the user of the mobile terminal (hereafter the user may be also referred to the driver of the vehicle) to selectively enter the mobile terminal into the safe driving mode when the vehicle has a speed higher than a determined speed, as illustrated in FIG. 2E. Consequentially, when the mobile terminal is in the safe driving mode, the incoming phone call or the incoming text message will be automatically processed by a predetermined processing method.

It is understood that the user may selectively activate the safe driving mode prompt based on actual needs; or, the mobile terminal may be controlled to automatically activate the safe driving mode prompt based on another actual needs. In one embodiment, it is determined that the safe driving mode prompt is activated when a control command, either triggered by the user selectively activating the safe driving mode prompt or the mobile terminal automatically activating the safe driving mode prompt, is received; alternatively, it is determined that the safe driving mode prompt is not activated if the control command is not received.

In one embodiment, the safe driving mode prompt is inactivated in response to a receiving of a control command for inactivating the safe driving mode prompt.

Step 203: determining that whether the mobile terminal is connected to a power supply of the vehicle or not. The control method in this embodiment goes to step 205 if yes; alternatively, the control method goes back to step 201 if no.

In one embodiment, the determination of whether the mobile terminal is connected to a power supply of the vehicle or not may be realized by detecting whether the mobile terminal is plugged into to the power supply of the vehicle or not. Specifically, it is determined that the mobile terminal is connected to a power supply of the vehicle if the mobile terminal is plugged into to the power supply of the vehicle; alternatively, it is determined that the mobile terminal is not connected to a power supply of the vehicle if the mobile terminal is not plugged into to the power supply of the vehicle. The determination of whether the user of the mobile terminal is driving the vehicle is based on the determination of whether the mobile terminal is connected to a power supply of the vehicle. That is, rather than a passenger, it is pretty common for a driver to plug his/her mobile terminal into a power supply of the vehicle while he/she is driving. Thus, by determining whether the mobile terminal is connected to a power supply of a vehicle, the user of the mobile terminal either being a driver or a passenger is determined.

Step 205: determining that the user of the mobile terminal is driving this vehicle, regularly obtaining a speed of the vehicle, calculating an average speed of the vehicle within a predetermined period according to the aforementioned obtained speed, and determining whether the average speed is higher than the predetermined speed or not. The control method in this embodiment goes to step 207 if yes; alternatively, the method goes back to step 205 if no.

In one embodiment, the speed of the vehicle may be obtained by regularly checking the data derived from GPS (Global Positioning System) chip, gyroscope or accelerometers disposed in the mobile terminal. In another embodiment, the aforementioned GPS chip, gyroscope or accelerometers may be disposed in the vehicle.

In one embodiment, the predetermined period may be any period such as two minutes and the predetermined speed may be set to, for example, 30 km/h.

Step 207: giving forth an alarm sound and determining whether the mobile terminal is in a safe driving mode. The control method in this embodiment goes to step 211 if yes; alternatively, the control method goes to step 209 if no.

In one embodiment, the mobile terminal is controlled to give forth an alarm sound to prompt the user to selectively enter the mobile terminal into the safe driving mode when the vehicle has an average speed higher than a predetermined speed within a predetermined period. Specifically, the alarm sound may be gave forth from a media player which is controlled by the mobile terminal, or, the alarm sound may be gave forth from a speaker of the mobile terminal; wherein the alarm sound may gave forth repeatly and with an increasing frequency. In one embodiment, the alarm sound may be, for example, “your speed is higher than 30 km/h, please selectively enter your mobile phone into the safe driving mode through a setting interface on your mobile phone.”

In one embodiment, the mobile terminal is controlled to display a prompt window on a display panel thereof for prompting the driver to selectively enter the mobile terminal into the safe driving mode when the alarm sound is being gave forth, as illustrated in FIG. 2B. In another embodiment, the mobile terminal may be controlled to automatically enter into the safe driving mode according to actual needs.

Furthermore, as illustrated in FIG. 2F, it is determined that the mobile terminal is entered into the safe driving mode when a control command, either trigger by the user selectively entering the mobile terminal into the safe driving mode or by the mobile terminal being automatically entered into the safe driving mode, is received; alternatively, it is determined that the mobile terminal is not entered into the safe driving mode if the control command is not received. In the safe driving mode and while the driver is driving, the incoming phone call or the incoming text messages will be automatically blocked if needed and consequentially the safety of the driver is guaranteed.

Preferably, the step 207 may include a sub step of: giving forth an alarm sound to prompt the driver to selectively enter the mobile terminal into the safe driving mode.

In one embodiment, the mobile terminal is controlled to display a prompt window on the display panel thereof for prompting the driver to selectively enter the mobile terminal into the safe driving mode when the alarm sound is being given forth.

Preferably, the step 207 may further include a sub step of: controlling the mobile terminal to enter into the safe driving mode in response to a receiving of the control command for controlling the mobile terminal to enter into the safe driving mode.

Step 209: not giving forth the alarm sound.

In one embodiment, the mobile terminal is controlled not to enter into the safe driving mode if either the user selectively determines not to enter the mobile terminal into the safe driving mode or the mobile terminal does not automatically enter into the safe driving mode, and accordingly the media player or the speaker are controlled not to give forth the alarm sound. In another embodiment, the stop of giving forth the alarm sound may continue in a specific period based on actual needs.

Step 211: obtaining a speed of the vehicle and the predetermined block condition when the incoming phone call or the incoming text message are received by the mobile terminal and determining whether there is a need to automatically block the incoming phone call or the incoming text message according to the obtained speed of the vehicle and the predetermined block condition or not. The control method in this embodiment goes to step 213 if yes; alternatively, the control method goes to step 215 if no.

Preferably, the step 211 may include a sub step of: determining whether there is a need to automatically block the incoming phone call or the incoming text message according to the predetermined block condition, such as the current speed of the vehicle, predetermined rules or predetermined black and white lists, etc.

In one embodiment, the predetermined block condition may relate to the speed of the vehicle. Specifically, it is determined that there is a need to automatically block the incoming phone call or the incoming text message when the vehicle is having a speed higher than a predetermined speed; wherein the predetermined speed may be set according to actual needs.

In another embodiment, the predetermined block condition may relate to the content, caller or sender of the incoming phone call or the incoming text message. For example, it is determined that there is a need to automatically block the incoming phone call or the incoming text message when the incoming text message is a commercial junk message or the caller or sender of the incoming phone call or the incoming text message are not in the contact list of the mobile terminal.

In other words, it is determined that there is a need to automatically block the incoming text message if the incoming text message is a commercial junk message. It is determined that there is a need to automatically block the incoming phone call or the incoming text message if the caller of the incoming phone call or the sender of the incoming text message are not in the contact list of the mobile terminal.

The aforementioned black list may include specific names and can be set in advance by the driver.

In one embodiment, it is determined that there is a need to automatically block the incoming phone call or the incoming text message if the caller of the incoming phone call or the sender of the incoming text messages are in the black list.

It is understood that the predetermined block condition may be set based on actual needs.

In one embodiment, the step 211 may be summarized to: automatically blocking the incoming phone call or the incoming text message if the vehicle is having an average speed higher than a predetermined speed, the incoming text message is a commercial junk message, the caller of the incoming phone call or the sender of the incoming text message are not in the contact list of the mobile terminal or the caller of the incoming phone call or the sender of the incoming text message are in the predetermined black list.

Step 213: automatically rejecting to answer the incoming phone call and automatically responding the incoming phone call or the incoming text message with a predetermined text message when it is determined that there is a need to automatically block the incoming phone call or the incoming text message.

In one embodiment, the aforementioned predetermined text message may have a content of, for example, “I'm driving now and this is an automatic reply message. I will call you or text you back as soon as possible.” The predetermined text message may be set in advance by the driver. In another embodiment, the predetermined text message may be represented by voice which may be recorded in advance by the driver.

Preferably, the step 213 may include a sub step of: controlling the mobile terminal not to give forth the ringtone or vibration sound corresponding to the incoming phone call or the incoming text message when the incoming phone call or the incoming text message are received by the mobile terminal.

In one embodiment, if there is a need to automatically block the incoming phone calls or text messages, the media player or the speaker are controlled by the mobile terminal not to give forth the ringtone or vibration sound corresponding to the incoming phone calls or text messages.

Preferably, the step 213 may further include a sub step of: recording and saving the incoming phone call or the incoming text message and displaying a specific information corresponding to the incoming phone call or the incoming text message on a display panel of the mobile terminal when it is determined that the incoming phone call or the incoming text message are needed to be automatically blocked, as illustrated in FIG. 2G.

In one embodiment, the recording of the automatically blocked incoming phone calls or text messages may be realized by first performing a blocking mark, such as marking the title of the incoming text message as a blocked text message and marking the incoming phone call as a blocked phone call, and recording related information such as the phone number and the calling time of the incoming phone calls.

Step 215: controlling the mobile terminal to communicate with the driver of the vehicle in a voice manner through a media player, identifying a reply from the driver, and determining whether the reply from the driver intends to answer the incoming phone call or check the incoming text message or not when the incoming phone call or the incoming text message are received by the mobile terminal and it is determined that the incoming phone call or the incoming text messages are not needed to be automatically blocked. The control method in this embodiment goes to step 217 if yes; alternatively, the control method goes to step 219 if no.

In one embodiment, the aforementioned voice gave forth from the media player or the speaker may contain specific content such as asking the driver whether or not to answer the incoming phone calls or check the incoming text messages. In another embodiment, the aforementioned voice gave forth from the media player or the speaker may further contain specific content such as instructing the driver to perform some simple voice controls.

Basically, the driver may answer the incoming phone calls or check the incoming text messages only in emergency situations.

Step 217: controlling the mobile terminal to automatically answer the incoming phone call and turning a volume of the incoming phone call up through a speaker, or controlling the mobile terminal to automatically display content of the incoming text message.

In one embodiment, the display of the content of the received incoming text message may be realized by first automatically opening the received incoming text message, controlling the media player to identify the content of the received incoming text message, and then playing the content of the received incoming text message.

Step 219: automatically responding the incoming phone call or the incoming text message with a predetermined text message when the reply from the driver intends not to answer the incoming phone call or not to check the incoming text message.

In one embodiment, the aforementioned predetermined text message may have a content of, for example, “I'm driving now and this is an automatic reply message. I will call you or text you back as soon as possible.” The predetermined text message may be set in advance by the driver. In another embodiment, the predetermined text message may be represented by voice which may be recorded in advance by the driver.

Step 221: calculating an average speed of the vehicle within a predetermined period according by regularly obtaining the speed of the vehicle and determining whether the average speed is lower than the predetermined speed or not and whether the mobile terminal is disconnected from the power supply of the vehicle. The control method in this embodiment goes to step 223 if yes; alternatively, the control method goes back to step 211 if no.

Step 223: controlling the mobile terminal to exit from the safe driving mode.

In one embodiment, the mobile terminal is control to automatically exit from the safe driving mode if an average speed of the vehicle lower than the predetermined speed or having a constant zero is detected.

In one embodiment, the mobile terminal may be controlled to give forth a voice through the media player or the speaker for prompting the driver that the mobile terminal has exited from the safe driving mode.

Preferably, the step 221 may include a sub step of: controlling the mobile terminal to exit from the safe driving mode in response to a receiving of a control command for exiting the mobile terminal from the safe driving mode.

In one embodiment, the aforementioned control command is generated when the user select to exit the mobile terminal from the safe driving mode; and consequentially the mobile terminal exits from the safe driving mode in response to a receiving of the aforementioned control command. It is understood that mobile terminal will process the incoming phone calls or text messages normally once the mobile terminal is controlled to exit from the safe driving mode.

In summary, by sequentially controlling a mobile terminal to enter into a safe driving mode, determining whether there is a need to automatically block the incoming phone call or the incoming text message or not according to an obtained predetermined block condition when the incoming phone call or the incoming text message are received by the mobile terminal, and automatically rejecting to answer the incoming phone call and automatically responding the incoming phone call or the incoming text message with a predetermined text message when it is determined that there is a need to automatically block the incoming phone call or the incoming text messages, the control method for incoming phone calls and text messages in accordance with an embodiment of the present invention can prevent the driver from being bothered by the incoming phone calls and text messages while driving and consequentially the safety of the driver is guaranteed.

In addition, by giving forth an alarm sound to prompt the driver to selectively enter the mobile terminal into the safe driving mode when a safe driving mode prompt is activated and the vehicle has an average speed higher than a predetermined speed within a predetermined period, the control method for incoming phone calls and text messages in accordance with an embodiment of the present invention can prompt the driver to selectively enter the mobile terminal into the safe driving mode in time and consequentially the safety of the driver is guaranteed.

In addition, by determining that whether the mobile terminal is connected to a power supply of a vehicle or not, the control method for incoming phone calls and text messages in accordance with an embodiment of the present invention can correctly determine that the user of the mobile terminal is a driver or a passenger, so as to prompt the driver to selectively enter the mobile terminal into the safe driving mode in time; and consequentially the safety of the driver is guaranteed.

In addition, by controlling the mobile terminal or a media player not to give forth ringtone or vibration sound corresponding to the incoming phone call or the incoming text message, recording and saving the automatically-blocked incoming phone call or text message and displaying specific information corresponding to the automatically blocked incoming phone call or text message on a display panel of the mobile terminal, the control method for incoming phone calls and text messages in accordance with an embodiment of the present invention can prevent the driver from being bothered by the incoming phone calls and text messages while driving and consequentially the safety of the driver is guaranteed.

In addition, by sequentially controlling the mobile terminal to communicate with the driver in voice manner through the media player or the speaker thereof, identifying the reply from the driver and determining whether the reply from the driver intends to answer the incoming phone call or check the incoming text message when the incoming phone call or the incoming text message are not needed to be automatically blocked, controlling the mobile terminal to automatically answer the incoming phone calls and turn the volume of the incoming phone call up through the speaker when the reply from the driver intends to answer the incoming phone call or to check the incoming text message or automatically respond the incoming phone call or the incoming text message with a predetermined text message when the reply from the driver intends not to answer the incoming phone call or not to check the incoming text message, the control method for incoming phone calls and text messages in accordance with an embodiment of the present invention can communicate with the driver when the incoming phone calls or text messages are not needed to be automatically blocked and response the incoming phone calls or text messages with a predetermined text message, so as to prevent the driver from being bothered by the incoming phone calls and text messages while driving and consequentially the safety of the driver is guaranteed.

In addition, by controlling the mobile terminal to automatically exit from the safe driving mode when an average speed of the vehicle is lower than a predetermined speed as well as the mobile terminal is disconnected from the vehicle power supply, the control method for incoming phone calls and text messages in accordance with an embodiment of the present invention can provide an easy and friendly operation for the driver to exit the mobile terminal from the safe driving mode.

Following is an apparatus embodiment of the present invention corresponding to the aforementioned described method embodiment. Please refer to the above-described method embodiment for more detailed information if necessary.

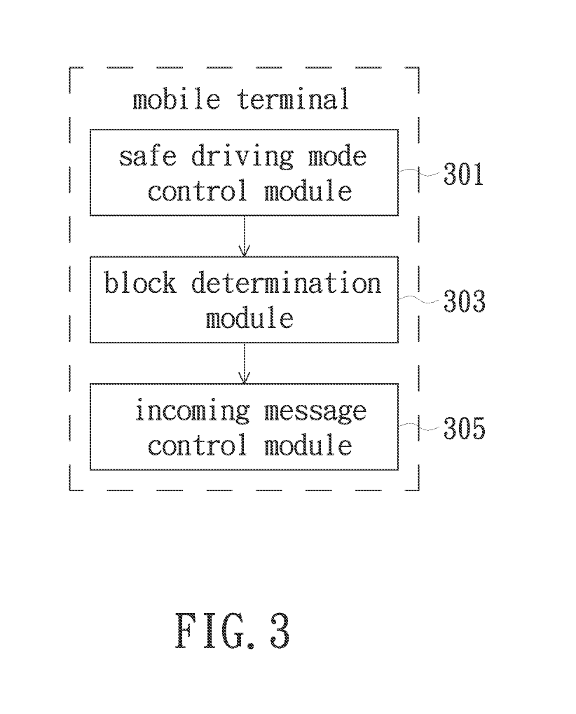

FIG. 3 is a schematic block view of a mobile terminal in accordance with an embodiment of the present invention. As shown, the mobile terminal in this embodiment includes: a safe driving mode control module 301, a block determination module 303 and an incoming message control module 305.

Specifically, the safe driving mode control module 301 is configured to control the mobile terminal to enter into a safe driving mode in response to a receiving of a command for controlling the mobile terminal to enter into the safe driving mode.

The block determination module 303 is configured to obtain a predetermined block condition and determine whether there is a need to automatically block an incoming phone call or an incoming text message or not according to the obtained predetermined block condition when the incoming phone call or the incoming text message are received by the mobile terminal.

The incoming message control module 305 is to automatically reject to answer the incoming phone call and automatically respond the incoming phone call or the incoming text message with a predetermined text message when it is determined that there is a need to automatically block the incoming phone call or the incoming text message.

In summary, by configuring the mobile terminal provided in this embodiment to enter into a safe driving mode, determine whether there is a need to automatically block the incoming phone call or the incoming text message or not according to an obtained predetermined block condition when the incoming phone call or the incoming text message are received by the mobile terminal, and automatically reject to answer the incoming phone call and automatically respond the incoming phone call or the incoming text message with a predetermined text message when it is determined that there is a need to automatically block the incoming phone call or the incoming text message. Thus, by way of automatically rejecting to answer the incoming phone call and automatically responding the incoming phone call or the incoming text message with a predetermined text message while a driver is driving a vehicle and the vehicle is having a relatively high speed, the driver can be prevented from being bothered by the incoming phone call or text message and consequentially the safety of the driver is guaranteed.

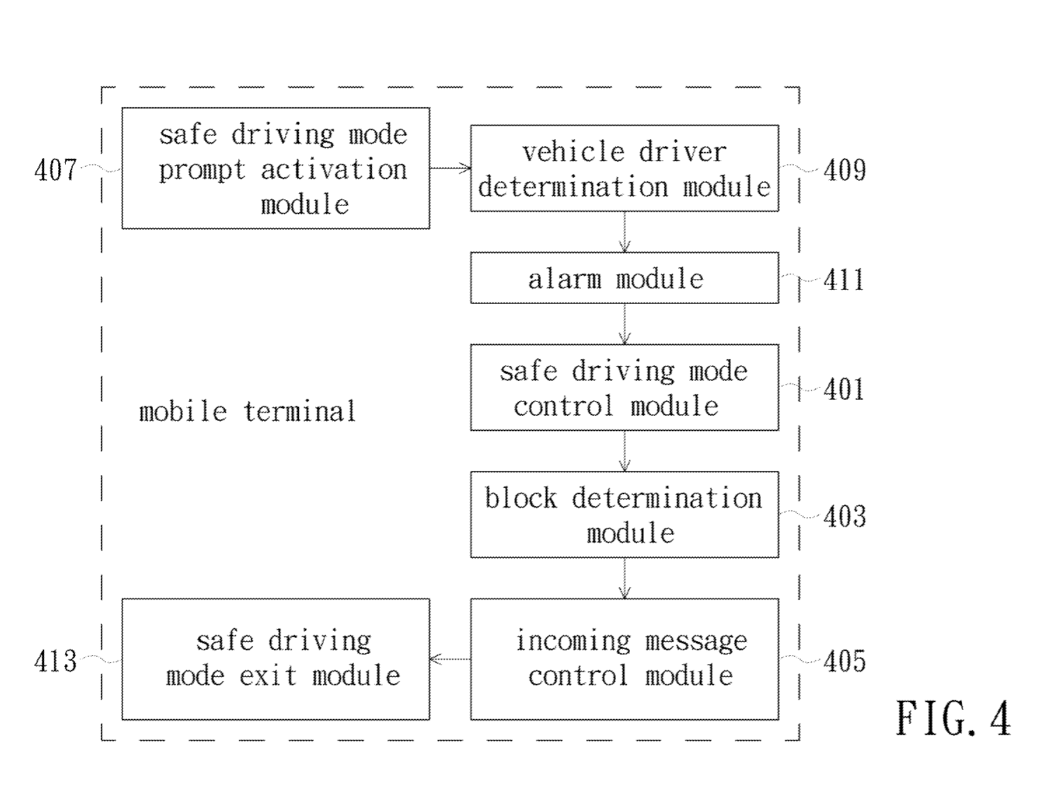

FIG. 4 is a schematic block view of a mobile terminal in accordance with another embodiment of the present invention. As shown, the mobile terminal in this embodiment includes: a safe driving mode control module 401, a block determination module 403 and an incoming message control module 405.

Specifically, the safe driving mode control module 401 is configured to control the mobile terminal to enter into a safe driving mode in response to a receiving of a command for controlling the mobile terminal to enter into the safe driving mode.

The block determination module 403 is configured to obtain a predetermined block condition and determine whether there is a need to automatically block an incoming phone call or an incoming text message or not according to the obtained predetermined block condition when the incoming phone call or the incoming text message are received by the mobile terminal.

The predetermined block condition includes: a vehicle connected with the mobile terminal is having a speed higher than a predetermined speed or not, the incoming text message is a junk text message or not, a caller of the incoming phone call or a sender of the incoming text message are not in a contact list of the mobile terminal or not, or the caller of the incoming phone call or the sender of the incoming text message are in a predetermined black list or not, wherein it is determined that the incoming phone call or the incoming text message are needed to be automatically blocked when the predetermined block condition is yes.

The incoming message control module 405 is to automatically reject to answer the incoming phone call and automatically respond the incoming phone call or the incoming text message with a predetermined text message when it is determined that there is a need to automatically block the incoming phone call or the incoming text message.

Preferably, the incoming message control module 405 is further configured to control a media player not to give forth a ringtone or a vibration sound corresponding to the incoming phone call or the incoming text message when it is determined that the incoming phone call or the incoming text message are needed to be automatically blocked.

Preferably, the incoming message control module 405 is further configured to record and save the incoming phone call or the incoming text message and display a specific information corresponding to the incoming phone call or the incoming text message on a display panel of the mobile terminal when it is determined that the incoming phone call or the incoming text message are needed to be automatically blocked.

Preferably, the incoming message control module 405 is further configured to control the mobile terminal to communicate with a driver of a vehicle connected with the mobile terminal in a voice manner through a media player, identify a reply from the driver, and determine whether the reply from the driver intends to answer the incoming phone call or check the incoming text message or not when the incoming phone call or the incoming text message are received by the mobile terminal and it is determined that the incoming phone call or the incoming text messages are not needed to be automatically blocked, wherein the incoming message control module is further configured to control the mobile terminal to automatically answer the incoming phone call and turn a volume of the incoming phone call up through a speaker, or control the mobile terminal to automatically display a content of the incoming text message when the reply from the driver intends to answer the incoming phone call or check the incoming text message, wherein the incoming message control module is further configured to automatically respond the incoming phone call or the incoming text message with a predetermined text message when the reply from the driver intends not to answer the incoming phone call or not to check the incoming text message.

Preferably, the mobile terminal in this embodiment may further include: a safe driving mode prompt activation module 407, a vehicle driver determination module 409, an alarm module 411 and a safe driving mode exit module 413.

The safe driving mode prompt activation module 407 is configured to determine that whether the mobile terminal has activated a safe driving mode prompt or not.

The vehicle driver determination module 409 is configured to determine that whether the mobile terminal is connected to a power supply of a vehicle or not when the safe driving mode prompt is activated, wherein it is determined that the vehicle is being driven by a user of the mobile terminal when it is determined that the motive terminal is connected to the power supply of the vehicle.

The alarm module 411 is configured to regularly obtain a speed of a vehicle connected with the mobile terminal, calculate an average speed of the vehicle within a predetermined period according to the obtained speed, determine whether the average speed is higher than a predetermined speed or not, and give forth an alarm sound to prompt the driver to selectively enter the mobile terminal into the safe driving mode when the average speed is higher than the predetermined speed.

The safe driving mode exit module 413 is configured to calculate an average speed of a vehicle connected with the mobile terminal within a predetermined period by regularly obtaining a speed of the vehicle, determine whether the average speed is lower than a predetermined speed or not and whether the mobile terminal is disconnected from a power supply of the vehicle, and control the mobile terminal to exit from the safe driving mode when the average speed is lower than the predetermined speed and the mobile terminal is disconnected from the power supply of the vehicle.

In summary, by sequentially controlling a mobile terminal to enter into a safe driving mode, determining whether there is a need to automatically block the incoming phone call or the incoming text message or not according to an obtained predetermined block condition when the incoming phone call or the incoming text message are received by the mobile terminal, and automatically rejecting to answer the incoming phone call and automatically responding the incoming phone call or the incoming text message with a predetermined text message when it is determined that there is a need to automatically block the incoming phone call or the incoming text messages, the mobile terminal in accordance with an embodiment of the present invention can prevent the driver from being bothered by the incoming phone calls and text messages while driving and consequentially the safety of the driver is guaranteed.

In addition, by giving forth an alarm sound for prompting the driver to selectively enter the mobile terminal into the safe driving mode when a safe driving mode prompt is activated and the vehicle has an average speed higher than a predetermined speed within a predetermined period, the mobile terminal in accordance with an embodiment of the present invention can prompt the driver to selectively enter the mobile terminal into the safe driving mode in time and consequentially the safety of the driver is guaranteed.

In addition, by determining that whether the mobile terminal is connected to a power supply of a vehicle or not, the mobile terminal in accordance with an embodiment of the present invention can correctly determine that the user of the mobile terminal is a driver or a passenger, so as to prompt the driver to selectively enter the mobile terminal into the safe driving mode in time; and consequentially the safety of the driver is guaranteed.

In addition, by controlling the mobile terminal or a media player not to give forth ringtone or vibration sound corresponding to the incoming phone call or the incoming text message, recording and saving the automatically-blocked incoming phone call or text message and displaying specific information corresponding to the automatically blocked incoming phone call or text message on a display panel of the mobile terminal, the mobile terminal in accordance with an embodiment of the present invention can prevent the driver from being bothered by the incoming phone calls and text messages while driving and consequentially the safety of the driver is guaranteed.

In addition, by sequentially controlling the mobile terminal to communicate with the driver in voice manner through the media player or the speaker thereof, identifying the reply from the driver and determining whether the reply from the driver intends to answer the incoming phone call or check the incoming text message when the incoming phone call or the incoming text message are not needed to be automatically blocked, controlling the mobile terminal to automatically answer the incoming phone calls and turn the volume of the incoming phone call up through the speaker when the reply from the driver intends to answer the incoming phone call or to check the incoming text message or automatically respond the incoming phone call or the incoming text message with a predetermined text message when the reply from the driver intends not to answer the incoming phone call or not to check the incoming text message, the mobile terminal in accordance with an embodiment of the present invention can communicate with the driver when the incoming phone calls or text messages are not needed to be automatically blocked and response the incoming phone calls or text messages with a predetermined text message, so as to prevent the driver from being bothered by the incoming phone calls and text messages while driving and consequentially the safety of the driver is guaranteed.

In addition, by controlling the mobile terminal to automatically exit from the safe driving mode when an average speed of the vehicle is lower than a predetermined speed as well as the mobile terminal is disconnected from the vehicle power supply, the mobile terminal in accordance with an embodiment of the present invention can provide an easy and friendly operation for the driver to exit the mobile terminal from the safe driving mode.

In addition, the ordinary skill in the art can understand that all or part of the steps in the aforementioned method embodiments can be realized by related hardware instructed by programs, the corresponding programs can be stored in a readable storage medium of computer, such as a ROM, RAM, disk or optical disk, etc.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the present claims which are to be accorded with the broadest interpretation so as to encompass all such modifications and similar structures.

What is claimed is:

1. A control method for incoming messages, comprising steps of:
controlling a mobile terminal to enter into a safe driving mode in response to a receiving of a command for controlling the mobile terminal to enter into the safe driving mode;
obtaining a predetermined block condition and determining whether there is a need to automatically block an incoming message or not according to the obtained predetermined block condition when the incoming message is received by the mobile terminal; and
rejecting or responding the incoming message with a predetermined message when it is determined that there is a need to automatically block the incoming message.

2. The control method according to claim 1, wherein before the step of controlling a mobile terminal to enter into a safe driving mode in response to a receiving of a command for controlling the mobile terminal to enter into the safe driving mode, the control method comprises steps of:
determining that whether the mobile terminal has activated a safe driving mode prompt or not;
determining that whether the mobile terminal is connected to a power supply of a vehicle or not when the safe driving mode prompt is activated; and
determining that the vehicle is being driven by a user of the mobile terminal when it is determined that the motive terminal is connected to the power supply of the vehicle.

3. The control method according to claim 1, wherein before the step of controlling a mobile terminal to enter into a safe driving mode in response to a receiving of a command for controlling the mobile terminal to enter into the safe driving mode, the control method comprises steps of:
regularly obtaining a speed of a vehicle connected with the mobile terminal, calculating an average speed of the vehicle within a predetermined period according to the obtained speed, and determining whether the average speed is higher than a predetermined speed or not; and
giving forth an alarm sound to prompt the driver to selectively enter the mobile terminal into the safe driving mode when the average speed is higher than the predetermined speed.

4. The control method according to claim 1, wherein the predetermined block condition comprises: a vehicle connected with the mobile terminal is having a speed higher than a predetermined speed or not, the incoming message is a junk message or not, a caller or a sender of the incoming message is not in a contact list of the mobile terminal or not, or the caller or the sender of the incoming message is in a predetermined black list or not, wherein it is determined that the incoming message is needed to be automatically blocked when the predetermined block condition is yes.

5. The control method according to claim 1, further comprising a step of:
controlling a media player not to give forth a ringtone or a vibration sound corresponding to the incoming message when it is determined that the incoming message is needed to be automatically blocked.

6. The control method according to claim 1, further comprising a step of:
recording and saving the incoming message and displaying a specific information corresponding to the incoming message on a display panel of the mobile terminal when it is determined that the incoming message is needed to be automatically blocked.

7. The control method according to claim 1, wherein after the step of obtaining a predetermined block condition and determining whether there is a need to automatically block an incoming message or not according to the obtained predetermined block condition when the incoming message is received by the mobile terminal, the control method comprises steps of:
controlling the mobile terminal to communicate with a driver of a vehicle connected with the mobile terminal in a voice manner through a media player, identifying a reply from the driver, and determining whether the reply from the driver intends to answer or check the incoming message or not when the incoming message is received by the mobile terminal and it is determined that the incoming message is not needed to be automatically blocked;
controlling the mobile terminal to automatically answer the incoming message and turn a volume of the incoming message up through a speaker, or controlling the mobile terminal to automatically display a content of the incoming message when the reply from the driver intends to answer or check the incoming message; and
automatically responding the incoming message with a predetermined message when the reply from the driver intends not to answer or not to check the incoming message.

8. The control method according to claim 1, wherein after the step of obtaining a predetermined block condition and determining whether there is a need to automatically block an incoming message or not according to the obtained predetermined block condition when the incoming message is received by the mobile terminal, the control method further comprises steps of:
calculating an average speed of a vehicle connected with the mobile terminal within a predetermined period by regularly obtaining a speed of the vehicle;
determining whether the average speed is lower than a predetermined speed or not and whether the mobile terminal is disconnected from a power supply of the vehicle; and
controlling the mobile terminal to exit from the safe driving mode when the average speed is lower than the predetermined speed and the mobile terminal is disconnected from the power supply of the vehicle.

9. A mobile terminal, comprising:
a safe driving mode control module configured to control the mobile terminal to enter into a safe driving mode in response to a receiving of a command for controlling the mobile terminal to enter into the safe driving mode;
a block determination module configured to obtain a predetermined block condition and determine whether there is a need to automatically block an incoming message or not according to the obtained predetermined block condition when the incoming message is received by the mobile terminal; and
an incoming message control module configured to reject or respond the incoming message with a predetermined message when it is determined that there is a need to automatically block the incoming message.

10. The mobile terminal according to claim 9, further comprising:
a safe driving mode prompt activation module configured to determine that whether the mobile terminal has activated a safe driving mode prompt or not; and
a vehicle driver determination module configured to determine that whether the mobile terminal is connected to a power supply of a vehicle or not when the safe driving mode prompt is activated, wherein it is determined that the vehicle is being driven by a user of the mobile terminal when it is determined that the motive terminal is connected to the power supply of the vehicle.

11. The mobile terminal according to claim 9, further comprising:
an alarm module configured to regularly obtain a speed of a vehicle connected with the mobile terminal, calculate an average speed of the vehicle within a predetermined period according to the obtained speed, determine whether the average speed is higher than a predetermined speed or not, and give forth an alarm sound to prompt the driver to selectively enter the mobile terminal into the safe driving mode when the average speed is higher than the predetermined speed.

12. The mobile terminal according to claim 9, wherein the predetermined block condition comprises: a vehicle connected with the mobile terminal is having a speed higher than a predetermined speed or not, the incoming message is a junk text message or not, a caller or a sender of the incoming message is not in a contact list of the mobile terminal or not, or the caller or the sender of the incoming message is in a predetermined black list or not, wherein it is determined that the incoming message is needed to be automatically blocked when the predetermined block condition is yes.

13. The mobile terminal according to claim 9, wherein the incoming message control module is further configured to control a media player not to give forth a ringtone or a vibration sound corresponding to the incoming message when it is determined that the incoming message is needed to be automatically blocked.

14. The mobile terminal according to claim 9, wherein the incoming message control module is further configured to record and save the incoming message and display a specific information corresponding to the incoming message on a display panel of the mobile terminal when it is determined that the incoming message is needed to be automatically blocked.

15. The mobile terminal according to claim 9, wherein the incoming message control module is further configured to control the mobile terminal to communicate with a driver of a vehicle connected with the mobile terminal in a voice manner through a media player, identify a reply from the driver, and determine whether the reply from the driver intends to answer or check the incoming message or not when the incoming message is received by the mobile terminal and it is determined that the incoming messages is not needed to be automatically blocked, wherein the incoming message control module is further configured to control the mobile terminal to automatically answer the incoming message and turn a volume of the incoming phone call up through a speaker, or control the mobile terminal to automatically display a content of the incoming message when the reply from the driver intends to answer or check the incoming message, wherein the incoming message control module is further configured to automatically respond the incoming message with a predetermined message when the reply from the driver intends not to answer or not to check the incoming message.

16. The mobile terminal according to claim 9, further comprising:
a safe driving mode exit module configured to calculate an average speed of a vehicle connected with the mobile terminal within a predetermined period by regularly obtaining a speed of the vehicle, determine whether the average speed is lower than a predetermined speed or not and whether the mobile terminal is disconnected from a power supply of the vehicle, and control the mobile terminal to exit from the safe driving mode when the average speed is lower than the predetermined speed and the mobile terminal is disconnected from the power supply of the vehicle.

17. A computer readable storage medium storing a program causing a mobile terminal to execute a control method, the control method comprising steps of:
controlling the mobile terminal to enter into a safe driving mode in response to a receiving of a command for controlling the mobile terminal to enter into the safe driving mode;
obtaining a predetermined block condition and determining whether there is a need to automatically block an incoming message or not according to the obtained predetermined block condition when the incoming message is received by the mobile terminal; and
rejecting or responding the incoming message with a predetermined message when it is determined that there is a need to automatically block the incoming message.
